(19) United States
(12) Patent Application Publication
(10) Pub. No.: US 2005/0124355 A1
(43) Pub. Date: Jun. 9, 2005

(54) Self-directed access point location validation

(75) Inventors: Daryl C. Cromer, Apex, NC (US); Philip J. Jakes, Durham, NC (US); Howard J. Locker, Cary, NC (US); Randall S. Springfield, Chapel Hill, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/727,427

(22) Filed: Dec. 4, 2003

(51) Int. Cl. H04Q 7/20

(52) U.S. Cl. 455/456.5; 455/456.1

(57) ABSTRACT

Aspects for validating access point locations in a wireless network are described. The aspects include performing a scan in a validating access point for another access point in the wireless network. Location data of a detected access point is utilized in the validating access point to direct self-correction of current location data of the validating access point.

### FIELD OF THE INVENTION

The present invention relates generally to wireless networks and more particularly, to self-directed access point location validation in a wireless network.

### BACKGROUND OF THE INVENTION

Implementation of computer-based wireless communication devices, including wireless LANs and wireless ready systems is a quickly emerging and evolving technology. Conventional computer-based wireless communication devices transmit radio frequency (RF) signals to wireless receivers of local area networks (LANs). These devices include transmitters that both transmit and receive wireless communication within a particular bandwidth in the highly regulated RF spectrum.

Conventional wireless computer networks are provided multiple frequency ranges with defined protocols to support wireless operations. These protocols include the 802.11b and 802.11g protocols, operating at ISM band for 2.4 GHz, and the U-NII HiperLAN/2 and other protocols, operating at U-NII for 5 Ghz, as well as 802.11a operating at 5.2 Ghz. Of course, other protocols that may emerge in the future for wireless networks would also be included. FIG. 1 illustrates a block diagram of an example of a typical wireless network. Included in the wireless network are access points 102, 104 for client systems 106, 108, such as laptop and hand-held computing devices, etc., within their range to communicate in accordance with the 802.11 standard. Access points 102, 104 also communicate via a wired network connection (e.g., Ethernet) 110, 112 to other devices, such as server systems (not shown).

Currently, location-aware computing in wireless networks allows new applications and usage models. However, to make location-aware computing work, a mobile client 106, 108 must know its physical location. Normally, mobile client locations are determined based on the locations of the access points 102, 104, which broadcast location data as part of a frame sent as a beacon. The physical location information sent in the beacon is preset and usually provides latitude, longitude, and attitude, or GPS (global positioning signal) data. Over time, the location information may become incorrect due to physical movements of the access points. It is also possible that the location is never programmed into an access point. Thus, the ability to rely on such data is hindered.

Accordingly, a need exists for a manner of ensuring valid location information in an access point.

### SUMMARY OF THE INVENTION

Aspects for validating access point locations in a wireless network are described. The aspects include performing a scan in a validating access point for another access point in the wireless network. Location data of a detected access point is utilized in the validating access point to direct self-correction of current location data of the validating access point.

With the present invention, an autonomic and self-correcting approach to access point location validation is achieved. In this manner, reliance on access point location data can be more readily trusted in location-aware computing. The above as well as additional objectives, features, and advantages of the present invention will become apparent in the following detailed written description.

### BRIEF DESCRIPTION OF THE DRAWINGS

FIG. 1 illustrates a block diagram of an example of a typical wireless network.

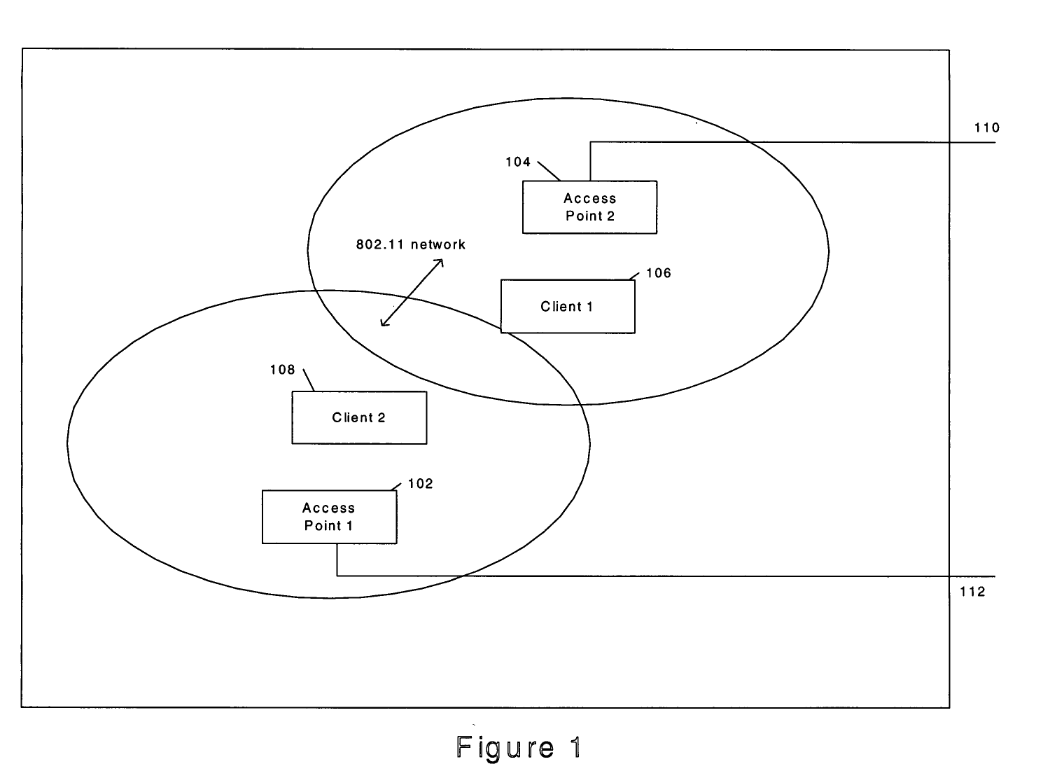

FIG. 2 illustrates a block diagram of an access point capable of self-directed location validation in accordance with a preferred embodiment of the present invention.

FIG. 3 illustrates a block flow diagram of a location validation check process in accordance with a preferred embodiment of the present invention.

FIG. 4a illustrates a block flow diagram of updating steps when a single other access point is located by the validating access point.

FIG. 4b illustrates a block diagram of updating steps when multiple other access points are located by the validating access point.

### DETAILED DESCRIPTION

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

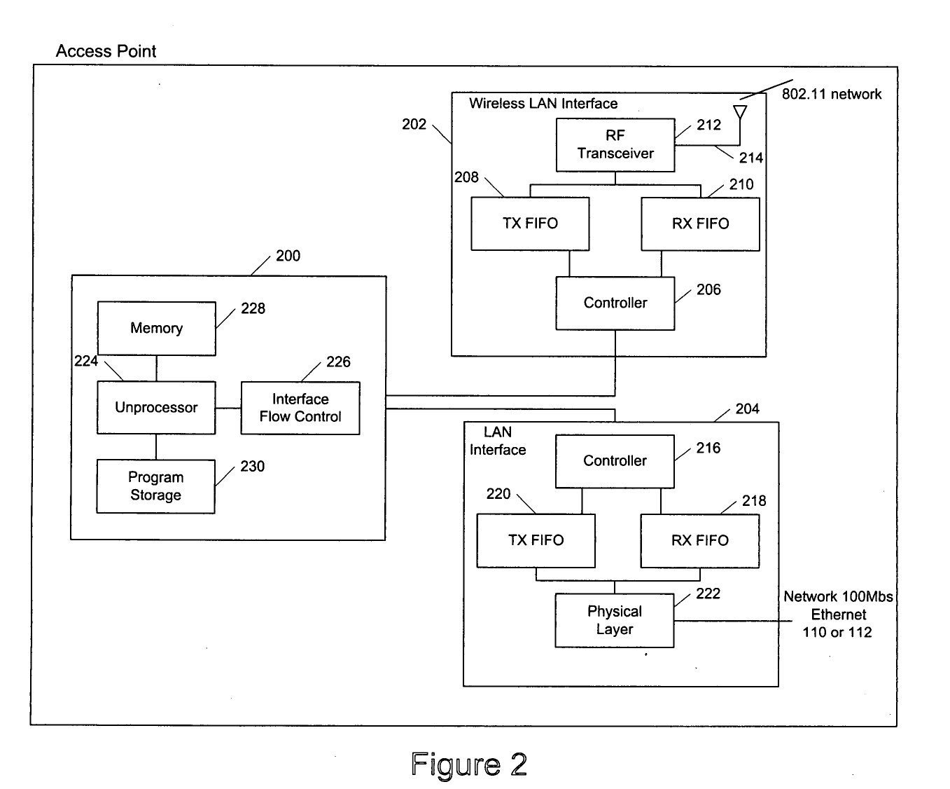

In accordance with the present invention, a location validation check is performed in access points for autonomic reconfiguration of access point physical locations. FIG. 2 illustrates a block diagram of an access point capable of self-directed location validation in accordance with a preferred embodiment of the present invention. As shown, an access point includes a processing unit 200 coupled to a wireless local area network interface unit (WLAN) 202 and coupled to a local area network interface unit (LAN) 204. A controller 206 interacts with the processing unit 200 and controls transmit and receive FIFOs 208 and 210 for data flow to/from an RF transceiver 212 interfacing via an antenna 214 with the wireless network. Similarly, controller 216 interacts with processing unit 200 and controls receive and transmit FIFOs 218 and 220 for data flow to/from an Ethernet network via the physical layer unit 222. The processing unit 200 includes a microprocessor 224 coupled to an interface flow control unit 226 which interacts with the WLAN 202 and LAN 204. The microprocessor 224 is further coupled to memory 228 and program storage 230. In addition to the typical activities associated with access points, the processing unit 200 perform a location validation check for autonomic reconfiguration of its physical location at predetermined intervals, such as once per day, via program instructions stored on a suitable computer readable medium (e.g., program storage 230), in a preferred embodiment of the present invention.

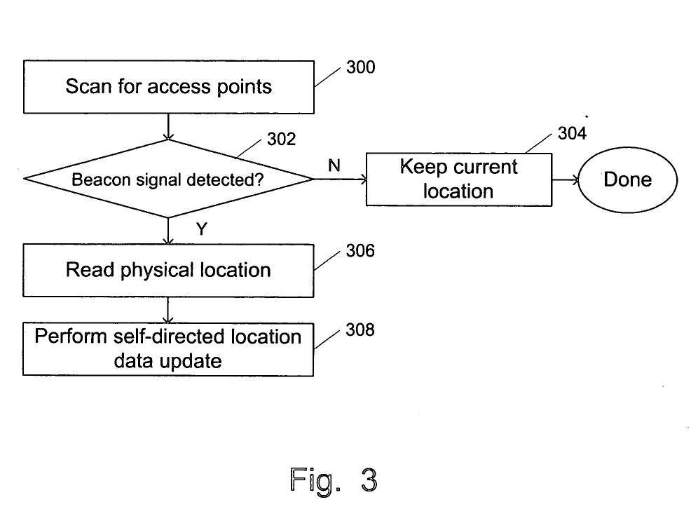

FIG. 3 illustrates a block flow diagram of a location validation check process in accordance with a preferred embodiment of the present invention. An access point initiates the validation process by scanning for other access points (step 300) and determining if another access point has been detected (step 302). When no other access point is found, the current location information in the validating access point is maintained (step 304). When one or more other access points are detected, the physical location(s) of the other access point(s) are read from their beacon data (step 306). It should be appreciated that although a beacon signal providing location data is described in a preferred embodiment as the manner in which the physical location of the other access point(s) is determined, any other method that may be used to determine the location data by an access point is suitable for inclusion in the present invention.

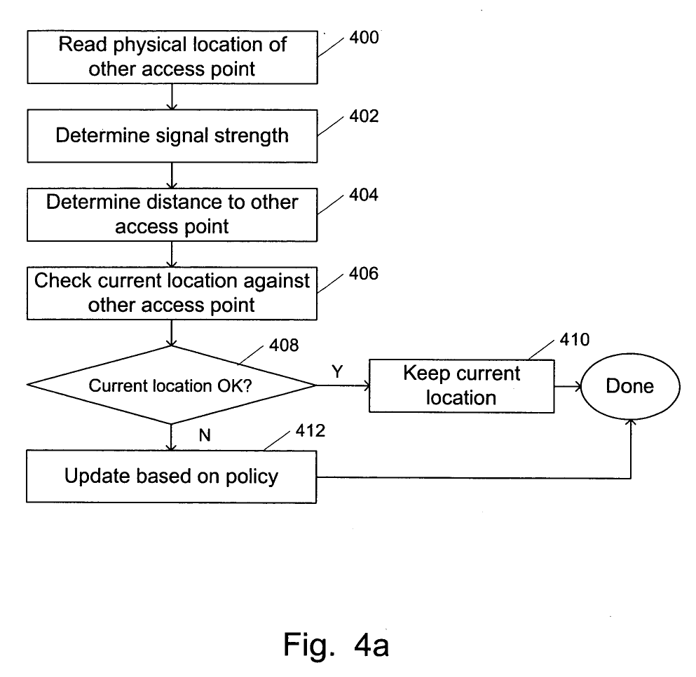

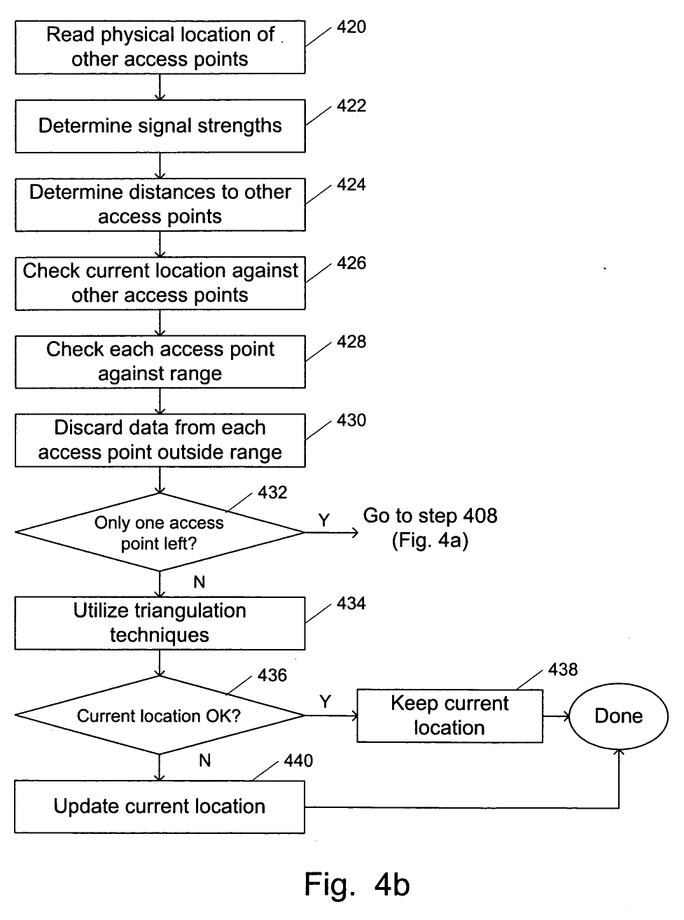

Based on the location data read, self-directed updating of the location within the validating access point occurs (step 308). FIG. 4a illustrates a block flow diagram of updating steps when a single other access point is located by the validating access point, while FIG. 4b illustrates a block diagram of updating steps when multiple other access points are located by the validating access point. Referring to FIG. 4a, updating of the location includes reading the physical location of the other access point (step 400), and determining the signal strength from the other access point (step 402). Based on the signal strength, the distance of the other access point from the validating access point is determined (step 404). For example, a signal strength of 100% would indicate a distance of 0 feet, while a signal strength of 1% would indicate a distance of 300 feet, with linear approximation providing distance data for values in between these signal strengths, as well understood by those skilled in the art.

The validating access point then checks its current physical location in comparison to the distance to the other access point and the location data provided by the other access point (step 406). When the comparison determines that the current location is substantially the same as the calculated location (step 408), the current location is maintained as correct (step 410) and the process is completed. When the comparison determines that the current location varies from the calculated location, the update occurs as dictated by a predetermined policy (step 412). For example, the location can be kept if it cannot be determined which location is correct, i.e., the other access point has a wrong location. Alternatively, the date that the location data of the other access point was last updated is checked and compared to the date of the validating access point last update. With only one other access point, knowing the exact location is not possible, since the exact location of the access point can be anywhere on a sphere with a radius equal to the distance value and the other access point at the center of the sphere. Therefore, the later dated location data is used. The process then is complete.

Referring to FIG. 4b, when multiple access points are detected, updating of the location utilizes triangulation techniques to determine the correct location. Thus, the location data is read from all of the other access points detected (step 420), and the signal strength from each of the other access points is determined (step 422). Based on the signal strength, the distance of each of the other access points is determined (step 424). For example, a signal strength of 100% would indicate a distance of a 0 feet, while a signal strength of 1% would indicate a distance of 300 feet, with linear approximation providing distance data for values in between these signal strengths, as well understood by those skilled in the art.

The validating access point then checks its current physical location in comparison to the distance to the other access points and the location data provided by the other access points (step 426). A determination is then done to see if any access points have wrong values (e.g., all access points must be within ±300 feet) (step 428). Any access points with a wrong value are discarded (step 430), and if that reduces the number of other access points to a single access point, the process proceeds to step 408. When more than one other access point remains, standard triangulation techniques are used to calculate the correct position for the validating access point (step 434). If the current location matches the calculated location (determined via step 436), the location is validated and kept (step 438). The process then is complete. If the current location does not match the calculated location, the location is set to the calculated location (step 440) and the process then is complete.

Although the invention has been described with reference to specific embodiments, this description should not be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

1. A method for validating access point locations in a wireless network, the method comprising:
performing a scan by a validating access point to detect and locate at least one access point in the wireless network; and
utilizing location data of at least one detected access point in the validating access point to direct self-correction of current location data of the validating access point.

2. The method of claim 1 wherein performing a scan further comprises detecting a beacon signal from at least one access point.

3. The method of claim 2 further comprising reading physical location data from the detected beacon signal.

4. The method of claim 1 wherein when there is one detected access point, the method further comprises comparing the current location data with a determined distance and the location data of the one detected access point.

5. The method of claim 4 wherein when the current location data compares favorably, the current location data is retained, and when the current location data compares unfavorably, the method further comprises determining if the location data is valid and updating the current location data if the location data is valid.

6. The method of claim 5 wherein determining if the location data is valid further comprises checking a date of last update of the location data.

7. The method of claim 1 wherein when there is more than one detected access point, the method further comprises eliminating a detected access point having invalid data.

8. The method of claim 7 wherein when more than one detected access point remains, the method further comprises utilizing triangulation techniques with the location data of the remaining detected access points to calculate a current position.

9. The method of claim 8 wherein when the current location data matches the current position, the current location data is retained, and when the current location data does not match the current position, the current location data is updated to the current position.

10. A system for validating access point locations, the system comprising:
a wireless network, the wireless network including a validating access point for performing a scan to detect another access point in the wireless network, wherein location data of the detected access point in the validating access point directs self-correction of current location data of the validating access point.

11. The system of claim 10 wherein the validating access point performs a scan to detect a beacon signal from another access point.

12. The system of claim 11 wherein the validating access point further reads physical location data from the detected beacon signal.

13. The system of claim 10 wherein when there is one detected access point, the validating access point compares the current location data with a determined distance and the location data of the one detected access point.

14. The system of claim 13 wherein when the current location data compares favorably, the current location data is retained by the validating access point, and when the current location data compares unfavorably, the validating access point determines if the location data is valid and updates the current location data if the location data is valid.

15. The system of claim 14 wherein determining if the location data is valid further comprises checking a date of last update of the location data.

16. The system of claim 10 wherein when there is more than one detected access point, the validating access point further eliminates a detected access point having invalid data.

17. The system of claim 16 wherein when more than one detected access point remains, the validating access point further utilizes triangulation techniques with the physical location data of the remaining detected access points to calculate a current position.

18. The system of claim 17 wherein when the current location data matches the current position, the current location data is retained by the validating access point, and when the current location data does not match the current position, the current location data is updated to the current position.

19. A computer readable medium containing program instructions for validating access point locations in a wireless network, the program instructions comprising:
scanning in a validating access point for another access point in the wireless network; and
utilizing location data in the validating access point of one or more detected access points to direct self-correction of current location data of the validating access point.

20. The computer readable medium of claim 19 further comprising reading physical location data and determining a signal strength from a detected beacon signal of each detected access point.

21. The computer readable medium of claim 20 further comprising determining a distance of each detected access point based on the signal strength and physical location data.

22. The computer readable medium of claim 19 wherein when there is one detected access point, the program instructions further comprise comparing the current location data with a determined distance and the location data of the one detected access point.

23. The computer readable medium of claim 22 wherein when the current location data compares favorably, the current location data is retained, and when the current location data compares unfavorably, the program instructions further comprise determining if the location data is valid and updating the current location data if the location data is valid.

24. The computer readable medium of claim 23 wherein determining if the location data is valid further comprises checking a date of last update of the location data.

25. The computer readable medium of claim 19 wherein when there is more than one detected access point, the program instructions further comprise eliminating a detected access point having invalid data.

26. The computer readable medium of claim 25 wherein when more than one detected access point remains, the program instructions further comprise utilizing triangulation techniques with the location data of the remaining detected access points to calculate a current position.

27. The computer readable medium of claim 26 wherein when the current location data matches the current position, the current location data is retained, and when the current location data does not match the current position, the current location data is updated to the current position.
